(19) United States
(12) Patent Application Publication
(10) Pub. No.: US 2026/0269580 A1
(43) Pub. Date: Sep. 10, 2026

(54) Fish Tape Unit with Assisted Fish Tape Retraction

(71) Applicant: Milwaukee Electric Tool Corporation, Brookfield, WI (US)

(72) Inventors: Kyle A. Ritz, Burlington, WI (US); Christian R. Braun, Milwaukee, WI (US); Ryan S. Dauss, Milwaukee, WI (US)

(21) Appl. No.: 19/465,438

(22) Filed: Jan. 30, 2026

Related U.S. Application Data
(60) Provisional application No. 63/767,989, filed on Mar. 6, 2025.
(60) Provisional application No. 63/843,559, filed on Jul. 14, 2025.
(60) Provisional application No. 63/869,728, filed on Aug. 25, 2025.
(60) Provisional application No. 63/925,884, filed on Nov. 26, 2025.

(51) Int. Cl. H02G 1/08

(52) U.S. Cl. CPC H02G 1/083

(57) ABSTRACT

Various embodiments of a fish tape unit with assisted fish tape retraction are provided. Various embodiments include assisted retracted that can work alone or in combination with user assistance.

### CROSS-REFERENCE TO RELATED PATENT APPLICATIONS

The present application claims the benefit of and priority to U.S. Provisional Application No. 63/925,884 filed on Nov. 26, 2025, U.S. Provisional Application No. 63/869,728 filed on Aug. 25, 2025, U.S. Provisional Application No. 63/843,559 filed on Jul. 14, 2025, and U.S. Provisional Application No. 63/767,989 filed on Mar. 6, 2025, each which is incorporated herein by reference in its entirety.

### BACKGROUND OF THE INVENTION

The present invention relates generally to the field of fish tape units. The present invention relates specifically to a fish tape unit including functionality to assist retraction of the fish tape.

### SUMMARY OF THE INVENTION

Various embodiments of the invention relate to a fish tape unit incorporating functionality to facilitate retracting the fish tape. In various embodiments, the invention relates to a unit configured for use in a modular storage system.

One embodiment of the invention relates to a fish tape unit including a housing defining a primary storage compartment and a lower surface, a lid coupled to the housing, a plurality of male couplers extending from the lower surface, each of the plurality of male couplers configured to detachably and rigidly engage with a female coupler of a utility module, a spool rotatably coupled to the housing within the primary storage compartment, a fish tape wound around the spool, the fish tape extending through a first aperture, the fish tape configured to be extended out of and retracted into the housing, wherein the first aperture is defined by one of the housing and the lid, and an electric motor. The electric motor is configured to exert a retrieving force that retracts the fish tape into the housing and winds the fish tape around the spool. The electric motor is configured to toggle between an off configuration and an on configuration. When the electric motor is in the on configuration the electric motor retracts the fish tape into the housing and winds the fish tape around the spool.

Another embodiment of the invention relates to a fish tape unit including a housing defining a primary storage compartment and a lower surface, a lid pivotally coupled to the housing, the lid defining an upper surface opposite the lower surface, a plurality of female couplers disposed at the upper surface, each of the plurality of female coupler configured to detachably and rigidly engage with a male coupler of a utility module, a spool rotatably coupled to the housing within the primary storage compartment, a fish tape wound around the spool, the fish tape extending through a first aperture, the fish tape configured to be extended out of and retracted into the housing. The first aperture is defined by one of the housing and the lid, and an electric motor. The electric motor is configured to exert a retrieving force that retracts the fish tape into the housing and winds the fish tape around the spool. The electric motor is configured to toggle between an off configuration and an on configuration. When the electric motor is in the on configuration the electric motor retracts the fish tape into the housing and winds the fish tape around the spool.

Another embodiment of the invention relates to a fish tape unit including a housing defining a primary storage compartment and a lower surface, a lid coupled to the housing, the lid defining an upper surface opposite the lower surface, a plurality of couplers located on one of the lower surface and the upper surface, each of the plurality of couplers configured to detachably and rigidly engage with a corresponding coupler of a utility module, a spool rotatably coupled to the housing within the primary storage compartment, a fish tape wound around the spool, the fish tape extending through a first aperture, the fish tape configured to be extended out of and retracted into the housing. The first aperture is defined by one of the housing and the lid, an electric motor, and a roller. The electric motor is configured to exert a retrieving force that biases the fish tape towards being retracted into the housing and around the spool. The electric motor is configured to toggle between an off configuration and an on configuration. When the electric motor is in the on configuration the electric motor exerts a retrieving force that biases the fish tape towards being retracted into the housing and around the spool. The roller interfaces with the fish tape as the fish tape is retracted into the housing and around the spool via the electric motor. When the electric motor is in the on configuration the electric motor rotates the roller with respect to the housing.

Another embodiment of the invention relates to a fish tape unit including a body defining a lower surface, a lid coupled to the body, a plurality of male couplers extending from the lower surface, each of the plurality of male couplers configured to engage with a female coupler of a utility module, fish tape, a carrier mounted within the body, the carrier configured to receive the fish tape that is wound around the carrier, a first aperture defined by one of the body and the lid, the fish tape configured to transit through the first aperture as the fish tape is extracted from and retracted into the carrier, and an electric motor configured to exert a retrieving force that biases the fish tape towards being retracted into the body and around the carrier. The electric motor is configured to toggle between an off configuration and an on configuration. When the electric motor is in the on configuration the electric motor exerts a retrieving force that biases the fish tape towards being retracted into the body and around the carrier.

Another embodiment of the invention relates to a fish tape unit including a body defining a lower surface, a lid pivotally coupled to the body, a plurality of male couplers extending from the lower surface, each of the plurality of male couplers configured to engage with a female coupler of a utility module, fish tape, a carrier mounted within the body, the carrier configured to receive the fish tape that is wound around the carrier, a first aperture defined by one of the body and the lid, the fish tape configured to transit through the first aperture as the fish tape is extracted from and retracted into the carrier, a biasing element configured to exert a retrieving force that biases the fish tape towards being retracted into the body and around the carrier, and a lever that actuates between a locked position and an unlocked position. When the lever is in the locked position the lever restricts the biasing element from retrieving the fish tape into the body and around the carrier.

Another embodiment of the invention relates to a fish tape unit including a body defining a lower surface, a lid coupled to the body, a plurality of male couplers extending from the lower surface, each of the plurality of male couplers configured to engage with a female coupler of a utility module, fish tape, a carrier mounted within the body, the carrier configured to receive the fish tape that is wound around the carrier, a first aperture defined by one of the body and the lid, the fish tape configured to transit through the first aperture as the fish tape is extracted from and retracted into the carrier, an electric motor configured to exert a retrieving force that biases the fish tape towards being retracted into the body and around the carrier, and a roller. The electric motor is configured to toggle between an off configuration and an on configuration. When the electric motor is in the on configuration, the electric motor exerts a retrieving force that biases the fish tape towards being retracted into the body and around the carrier. The roller interfaces with the fish tape as the fish tape is retracted into the body and around the carrier via the electric motor. When the electric motor is in the on configuration, the electric motor rotates the roller with respect to the body.

In specific embodiments, the fish tape unit includes an idler configured to exert a varying amount of tensioning force on the fish tape as the electric motor retracts the fish tape into the body and around the carrier.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a fish tape unit, according to an exemplary embodiment.

FIG. 2 is a bottom view of the fish tape unit of FIG. 1, according to an exemplary embodiment.

FIG. 3 is a detailed perspective view of a portion of the fish tape unit of FIG. 1, according to an exemplary embodiment.

FIG. 4 is a cross-section side view of a portion of the fish tape unit of FIG. 1, according to an exemplary embodiment.

FIG. 5 is a perspective view of the fish tape unit of FIG. 1 coupled to a modular system, according to an exemplary embodiment.

FIG. 6 is a perspective view of the fish tape unit of FIG. 1 coupled to a modular system, according to an exemplary embodiment.

FIG. 7 is a perspective view of the fish tape unit of FIG. 1, according to an exemplary embodiment.

FIG. 8 is a perspective view of the fish tape unit of FIG. 1, according to an exemplary embodiment.

FIG. 9 is a detailed perspective view from below of a male coupler of the fish tape unit of FIG. 1, according to an exemplary embodiment.

FIG. 10 is a detailed perspective view from below of a male coupler of the fish tape unit of FIG. 1, according to an exemplary embodiment.

FIG. 11 is a perspective view of a fish tape unit, according to another exemplary embodiment.

FIG. 12 is a perspective view of the fish tape unit of FIG. 11, according to an exemplary embodiment.

FIG. 13 is a top view of a portion of the fish tape unit of FIG. 11, according to an exemplary embodiment.

FIG. 14 is a perspective view of a portion of the fish tape unit of FIG. 11, according to an exemplary embodiment.

FIG. 15 is a perspective view of a portion of the fish tape unit of FIG. 11, according to an exemplary embodiment.

FIG. 16 is a perspective view of a portion of the fish tape unit of FIG. 11, according to an exemplary embodiment.

FIG. 17 is a perspective view of a portion of the fish tape unit of FIG. 11, according to an exemplary embodiment.

FIG. 18 is a perspective view of a portion of the fish tape unit of FIG. 11, according to an exemplary embodiment.

FIG. 19 is a perspective view of a portion of the fish tape unit of FIG. 11, according to an exemplary embodiment.

FIG. 20 is a perspective view of the fish tape unit of FIG. 11 coupled to a modular system, according to an exemplary embodiment.

FIG. 21 is a perspective view of the fish tape unit of FIG. 11 coupled to a modular system, according to an exemplary embodiment.

FIG. 22 is a perspective view of the fish tape unit of FIG. 11, according to an exemplary embodiment.

FIG. 23 is a perspective view of the fish tape unit of FIG. 11, according to an exemplary embodiment.

FIG. 24 is a perspective view of a fish tape unit, according to another exemplary embodiment.

FIG. 25 is a top view of the fish tape unit of FIG. 24, according to an exemplary embodiment.

FIG. 26 is a perspective view of a portion of the fish tape unit of FIG. 24, according to an exemplary embodiment.

FIG. 27 is a perspective cross-section view of a portion of the fish tape unit of FIG. 24, according to an exemplary embodiment.

FIG. 28 is a perspective view of a portion of the fish tape unit of FIG. 24, according to an exemplary embodiment.

FIG. 29 is a top view of a portion of the fish tape unit of FIG. 24, according to an exemplary embodiment.

FIG. 30 is a perspective view of a portion of the fish tape unit of FIG. 24, according to an exemplary embodiment.

FIG. 31 is a top view of a portion of the fish tape unit of FIG. 24, according to an exemplary embodiment.

FIG. 32 is a perspective view of a portion of the fish tape unit of FIG. 24, according to an exemplary embodiment.

FIG. 33 is a perspective cross-section view of a portion of the fish tape unit of FIG. 24, according to an exemplary embodiment.

FIG. 34 is a perspective view of a portion of the fish tape unit of FIG. 24, according to an exemplary embodiment.

FIG. 35 is a perspective view of a portion of the fish tape unit of FIG. 24, according to an exemplary embodiment.

FIG. 36 is a perspective view of the fish tape unit of FIG. 24 coupled to a modular system, according to an exemplary embodiment.

FIG. 37 is a perspective view of the fish tape unit of FIG. 24, according to an exemplary embodiment.

FIG. 38 is a perspective view of the fish tape unit of FIG. 24, according to an exemplary embodiment.

FIG. 39 is a perspective view of a remote control used with the fish tape unit of FIG. 24, according to an exemplary embodiment.

FIG. 40 is a perspective view of a fish tape unit, according to another exemplary embodiment.

FIG. 41 is a perspective view of the fish tape unit of FIG. 40, according to an exemplary embodiment.

FIG. 42 is a perspective view of the fish tape unit of FIG. 40, according to an exemplary embodiment.

FIG. 43 is a bottom view of a fish tape unit, according to another exemplary embodiment.

FIG. 44 is a side cross-section view of the fish tape unit of FIG. 43, according to an exemplary embodiment.

FIG. 45 is a top view of the fish tape unit of FIG. 43, according to an exemplary embodiment.

FIG. 46 is a top view of the fish tape unit of FIG. 43, according to an exemplary embodiment.

FIG. 47 is a top view of the fish tape unit of FIG. 43, according to an exemplary embodiment.

FIG. 48 is a perspective view of a fish tape unit, according to another exemplary embodiment.

FIG. 49 is a perspective view of a modular system including the fish tape unit of FIG. 48, according to an exemplary embodiment.

FIG. 50 is a perspective view of a modular system including the fish tape unit of FIG. 48, according to an exemplary embodiment.

FIG. 51 is a bottom view of the fish tape unit of FIG. 48, according to an exemplary embodiment.

FIG. 52 is a perspective view of the fish tape unit of FIG. 48, according to an exemplary embodiment.

FIG. 53 is a cross-section view of a portion of the fish tape unit of FIG. 48, according to an exemplary embodiment.

FIG. 54 is a cross-section view of a modular system including the fish tape unit of FIG. 48, according to an exemplary embodiment.

FIG. 55 is a perspective view of the fish tape unit of FIG. 48, according to an exemplary embodiment.

FIG. 56 is a perspective view of the female coupler of FIG. 11, according to an exemplary embodiment.

### DETAILED DESCRIPTION

Referring generally to the figures, various embodiments of a fish tape unit that provides assisted fish tape retraction are provided. In addition, various embodiments of a fish tape unit include coupling components for engagement of the fish tape unit within a modular system, such as a modular storage system.

In specific embodiments, the fish tape unit includes coupling mechanism(s) (e.g., male and/or female coupling component(s)) configured to engage with units of a modular storage system, such as a modular or stackable tool storage system, a modular worksite storage system, a modular transit storage system, etc.

In specific embodiments, the modular storage unit discussed herein include one or more female couplers and/or one or more male couplers located on a surface of the unit and that are configured to engage one or more corresponding mating couplers of an adjacent modular unit (e.g., a modular tool storage container, a modular utility module, a modular support component, etc.). In various embodiments, the male and female couplers described herein and shown in the figures are compatible with the coupling mechanism(s) described in International Patent International Patent Publication No. WO 2017/191628, which is hereby incorporated by reference in its entirety. In various embodiments, the female couplers and male couplers described herein engage with each other to rigidly couple together various components including such coupling structures. Various embodiments of the fish tape units described herein include multiple (e.g., six) male couplers extending from a bottom surface of the fish tape unit, the male couplers structurally the same as or similar to the male couplers described in International Patent International Patent Publication No. WO 2017/191628.

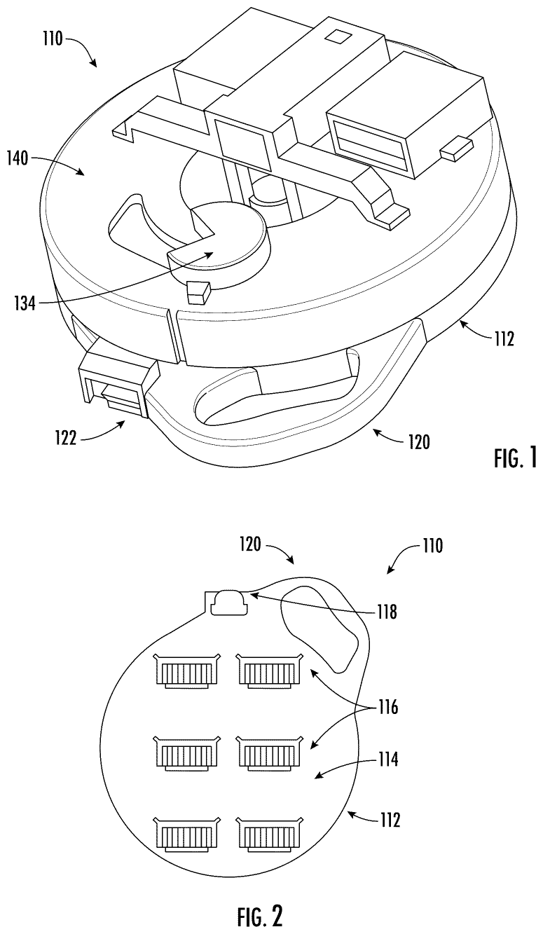

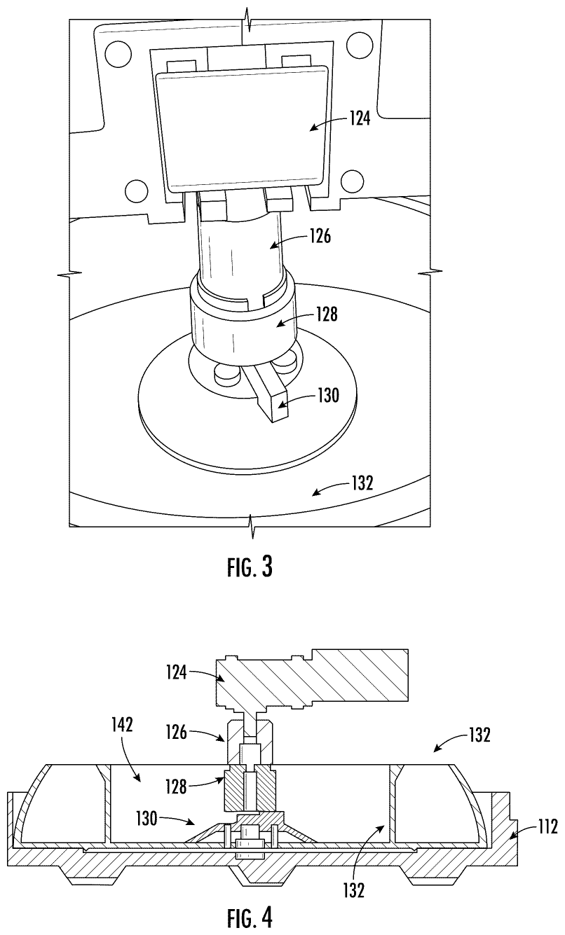

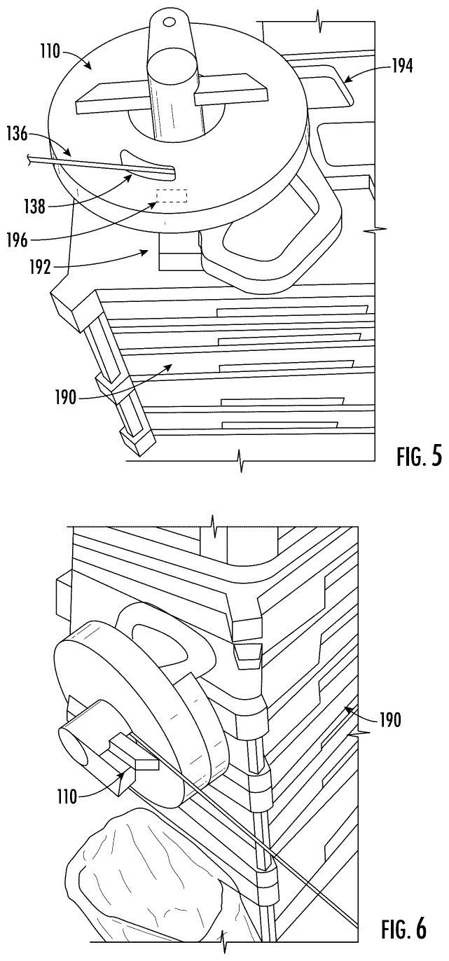

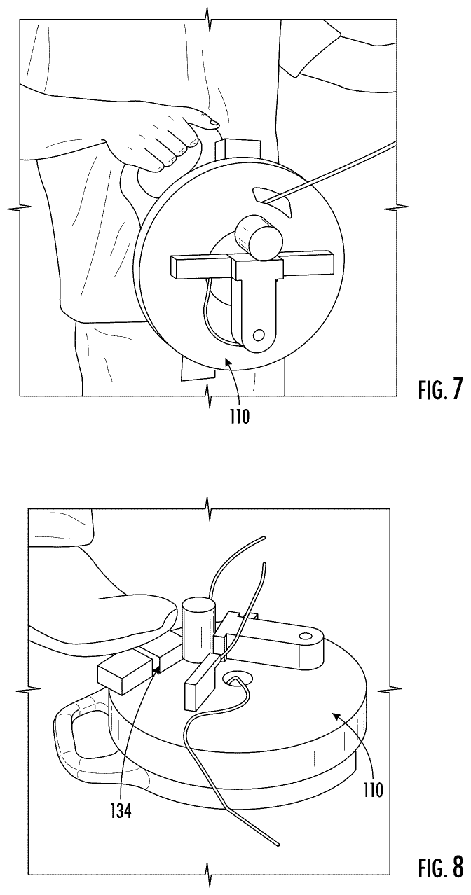

Referring to FIGS. 1-10 various aspects of fish tape unit 110 are provided. Fish tape unit includes a housing 112 defining a lower surface 114, a lid 140 coupled to the housing 112, a plurality of male couplers 116 extending from the lower surface 114, fish tape 136, a spool 132 mounted within the housing 112, the spool 132 configured to receive the fish tape 136 that is wound around the spool 132, a first aperture 138 defined by one of the housing 112 and the lid 140, the fish tape 136 configured to transit through the first aperture 138 as the fish tape 136 is extracted from and retracted into the spool 132, and an electric motor 124. Spool 132 is rotatably coupled to the housing 112 within the primary storage compartment 142. Fish tape 136 is wound around the spool 132, the fish tape 136 extending through a first aperture 138, the fish tape 136 configured to be extended out of and retracted into the housing 112, and the first aperture 138 is defined by one of the housing 112 and the lid 140. The electric motor 124 is configured to exert a retrieving force that retracts the fish tape 136 into the housing 112 and winds the fish tape 136 around the spool 132. The electric motor 124 toggles between an off configuration and an on configuration. When the electric motor 124 is in the on configuration the electric motor 124 retracts the fish tape 136 into the housing 112 and winds the fish tape 136 around the spool 132.

Fish tape unit 110 includes the housing 112 defining a primary storage compartment 142 and a lower surface 114, and a lid 140 coupled to the housing 112. Fish tape unit 110 includes a plurality of male couplers 116 extending from the lower surface 114, each of the plurality of male couplers 116 configured to detachably and rigidly engage with a female coupler of a utility module. Each of the plurality of male coupler 116 are configured to engage with a female coupler of a utility module (e.g., female coupler 194 of utility module 192). Fish tape unit 110 includes latch 118, configured to interface with a latch recess (e.g., latch recess 196 of FIG. 5, shown schematically) of the utility module (e.g., utility module 192) the male couplers 116 are coupled to, thereby restricting the male couplers 116 from disengaging from the female couplers of the utility module.

Fish tape unit 110 includes handle 120 extending from housing 112, and button 122 slidably coupled to handle 120. Button 122 toggles electric motor 124 between the off configuration and the on configuration. In use, drive tool 126 of electric motor 124 spins clutch 128, which rotates lower drive 130 and spool 132, and as a result retrieves fish tape 136 into spool 132. Fish tape unit 110 includes lid 140 coupled to housing 112, such as pivotally coupled.

Fish tape unit 110 further includes foot button 134. In various embodiments, foot button 134 is configured to be actuated by a foot of a user, such as if fish tape unit 110 is on the ground (see FIG. 8), and the foot button 134 actuates the electric motor 124 between the off configuration and the on configuration.

Referring to FIGS. 5-8, fish tape unit 110 is shown in various positions, such as coupled to a modular system 190.

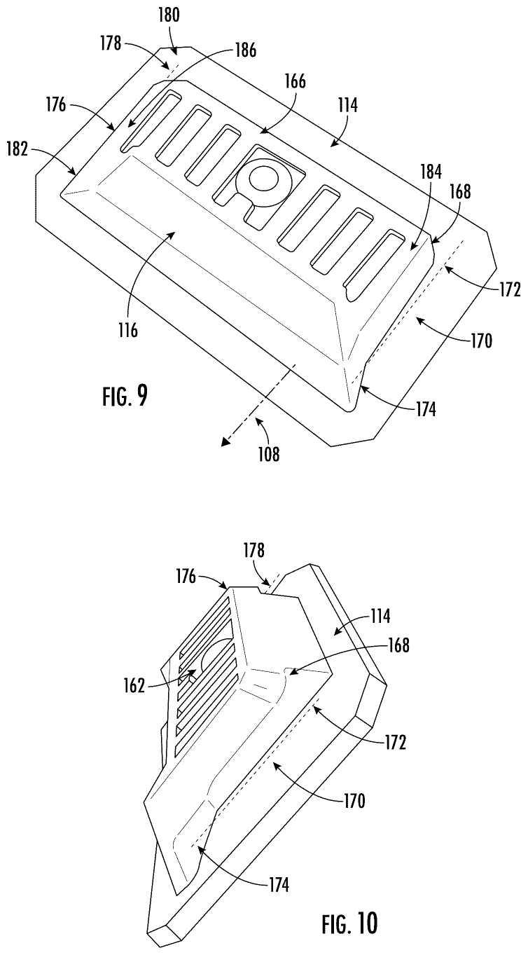

Referring to FIGS. 9-10, in various embodiments, fish tape unit 110 includes a plurality of male couplers 116, each of which extending from lower surface 114 of housing 112. Male coupler 116 includes a body 166 extending below the lower surface 114, a first tongue 168, and a second tongue 176. The first tongue 168 and the second tongue 176 both extend from the body 166 and both are offset from and below the lower surface 114. The first tongue 168 defines a first channel 170 between the lower surface 114 and the first tongue 168, and the second tongue 176 defines a second channel 178 between the lower surface 114 and the second tongue 176. The first channel 170 and second channel 178 each extend on opposing sides (e.g., first side 184 and opposing second side 186) of the body 166.

In various embodiments, each of the plurality of male couplers 116 includes a body 166 extending below the lower surface 114 and a first tongue 168 extending from the body 166 and offset from and below the lower surface 114. In various embodiments, the first tongue 168 defines a first channel 170 between the lower surface 114 and the first tongue 168, the first channel 170 including a front open end 172 and a back closed end 174.

Each of first channel 170 and second channel 178 includes a front open end 172, 180 and a back closed end 174, 182. For example, first channel 170 includes a front open end 172 and a back closed end 174, and second channel 178 includes a front open end 180 and a back closed end 182.

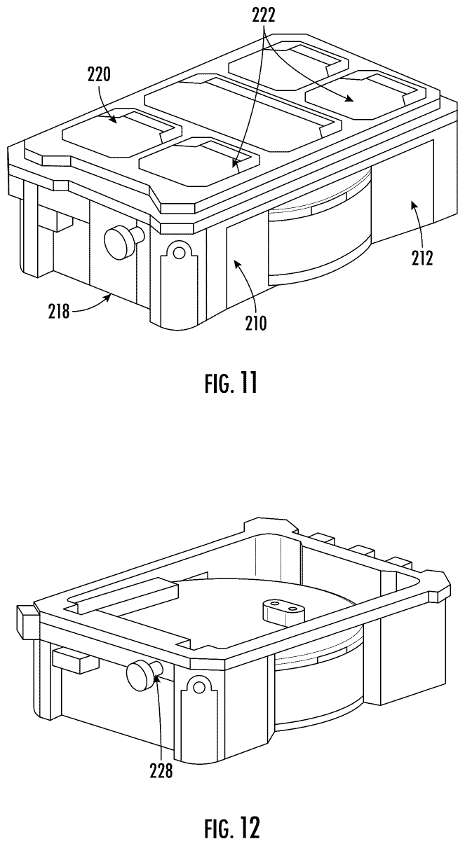

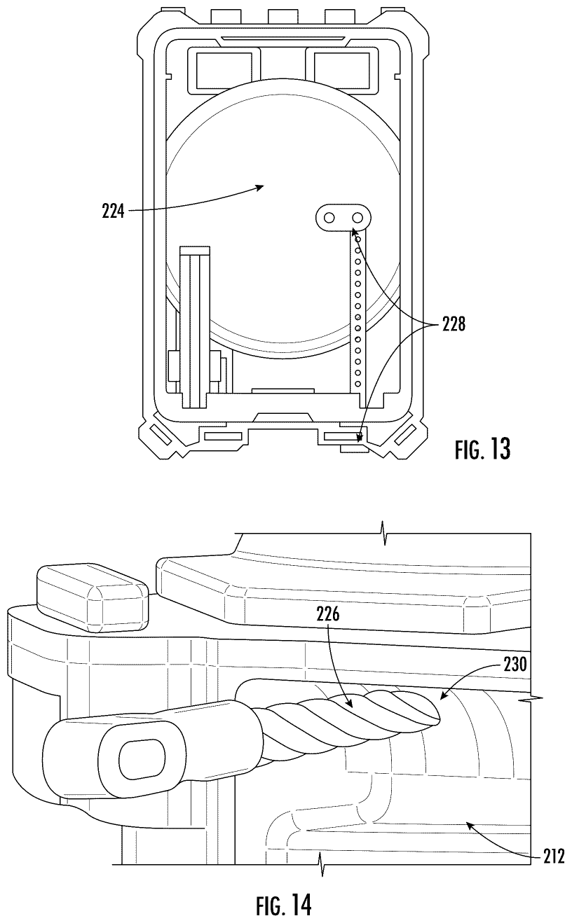

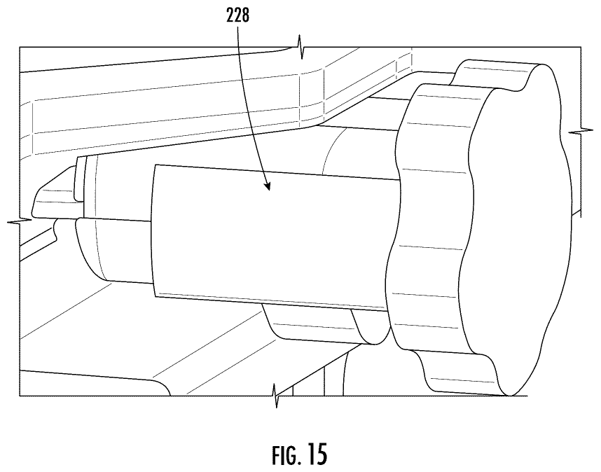

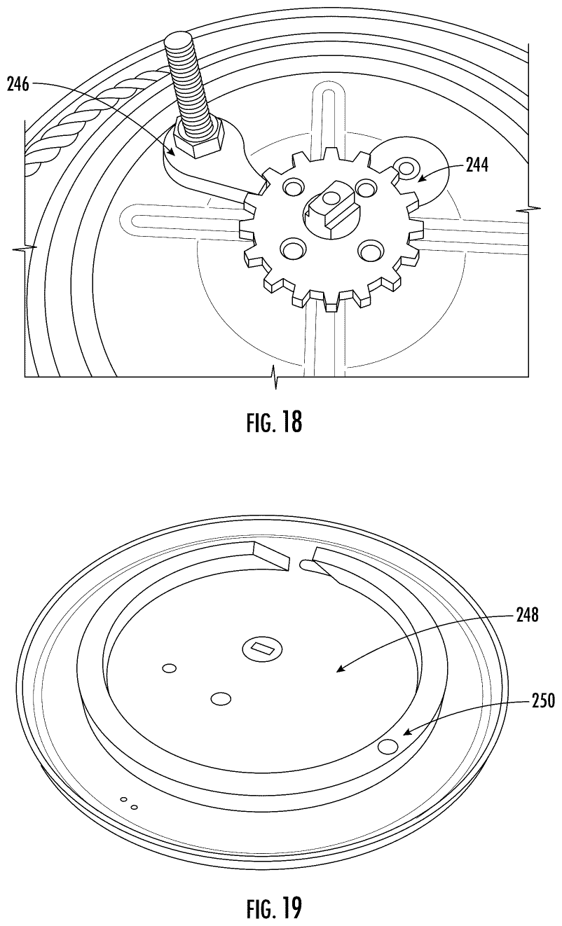

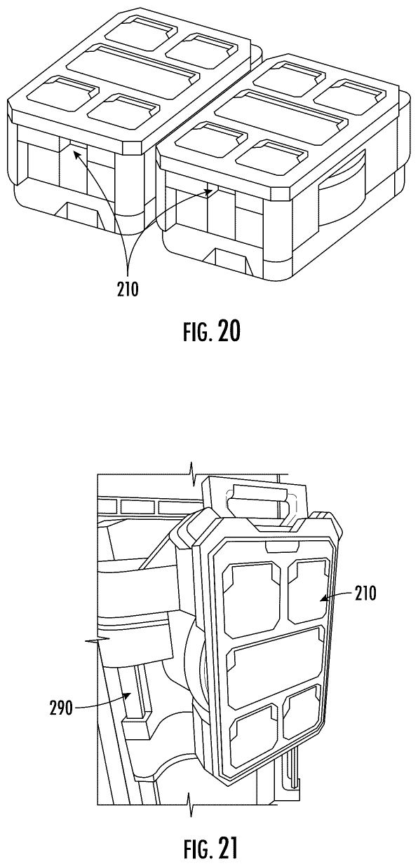

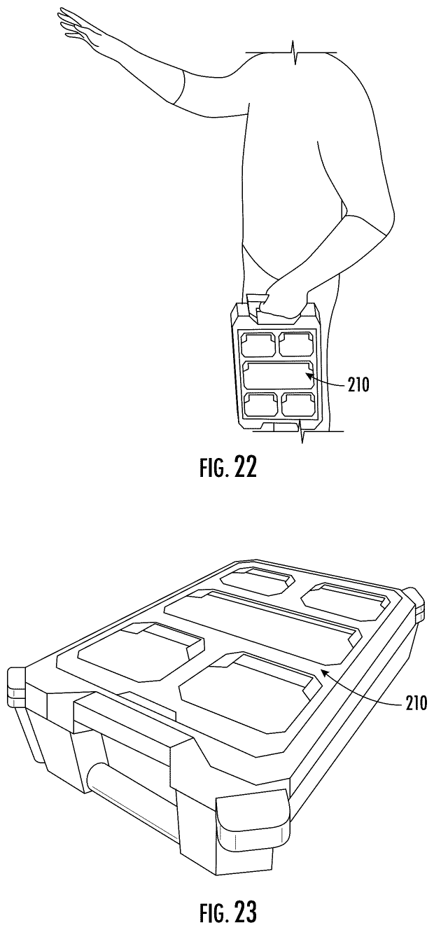

Referring to FIGS. 11-23 various aspects of fish tape unit 210 are provided. Fish tape unit 210 is substantially the same as fish tape unit 110 except for the differences discussed herein. In various embodiments, fish tape unit 210 has a manual payout of the fish tape 226 from fish tape unit 210, and a spring assisted retraction of the fish tape 226.

Fish tape unit 210 includes body 212, latch 218 that, when engaged with a latch recess, biases male couplers of fish tape unit 210 from disengaging with female couplers. Fish tape unit 210 includes lid 220 coupled to body 212, such as pivotally coupled. Lid 220 defines one or more female couplers 222.

Fish tape unit 210 includes fish tape 226, a carrier 224 mounted within the housing 112, the carrier 224 configured to receive the fish tape 226 that is wound around the carrier 224, a first aperture 230 defined by one of the body 212 and the lid 220, the fish tape 226 configured to transit through the first aperture 230 as the fish tape 226 is extracted from and retracted into the carrier 224, a biasing element, such as a spring in spring housing 242, configured to exert a retrieving force that biases the fish tape 226 towards being retracted into the body 212 and around the carrier 224, and a lever 228. Lever 228 actuates between a locked position and an unlocked position. When the lever 228 is in the locked position the lever 228 restricts the biasing element from retrieving the fish tape 226 into body 212 and around the carrier 224, such as by lever 228 restricting rotation of carrier 224.

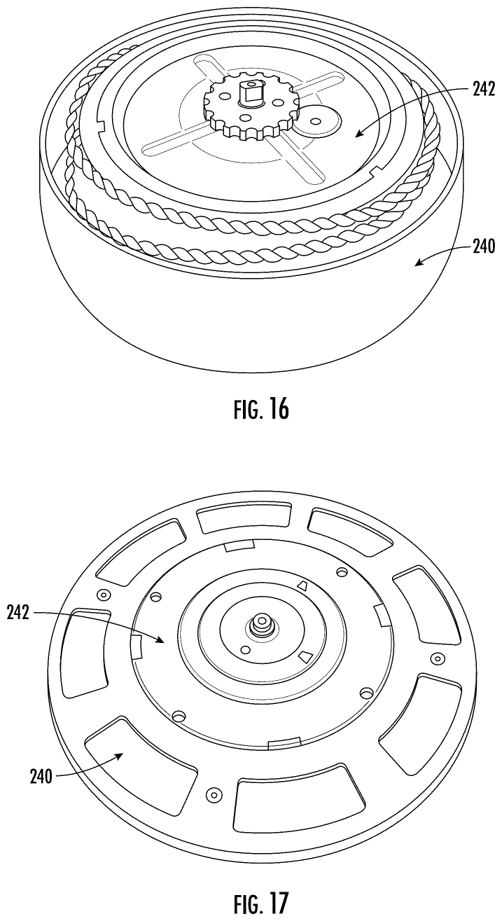

Referring to FIGS. 16-21, fish tape unit 210 includes drum 240 that contains fish tape 226, spring housing 242 that houses the spring that gets loaded with force as fish tape 226 is retrieved from fish tape unit 210, gear 244, ratchet 246 engaged with gear 244, plate 248, and guide ring 250. Gear 244 and ratchet 246 bias fish tape 226 from respooling and creates the biasing force when fish tape 226 is paid out from fish tape unit 210. Guide ring 250 includes the fish tape 226 in drum 240, and provides a path for fish tape 226 to exit body 212.

Referring to FIGS. 20-23, fish tape unit 210 is shown in various positions, such as coupled to a modular system 290.

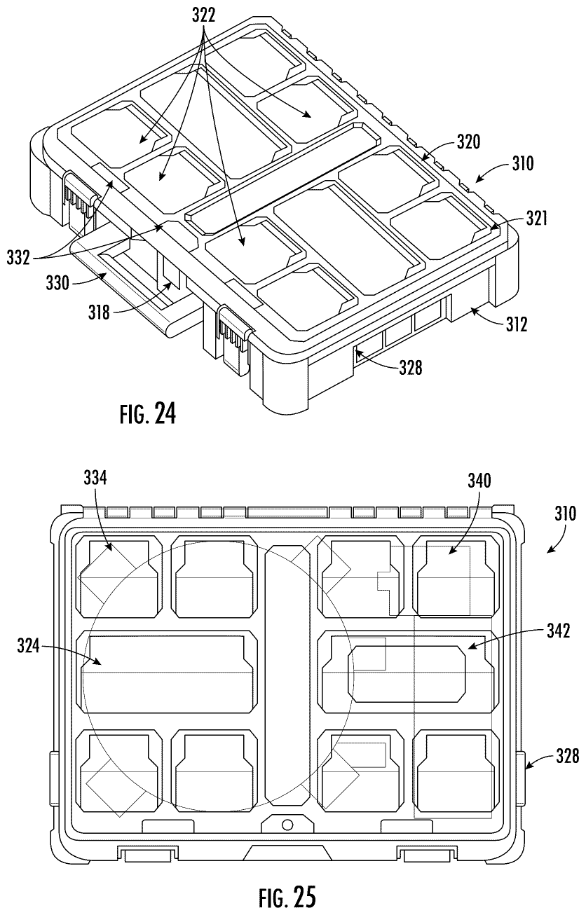

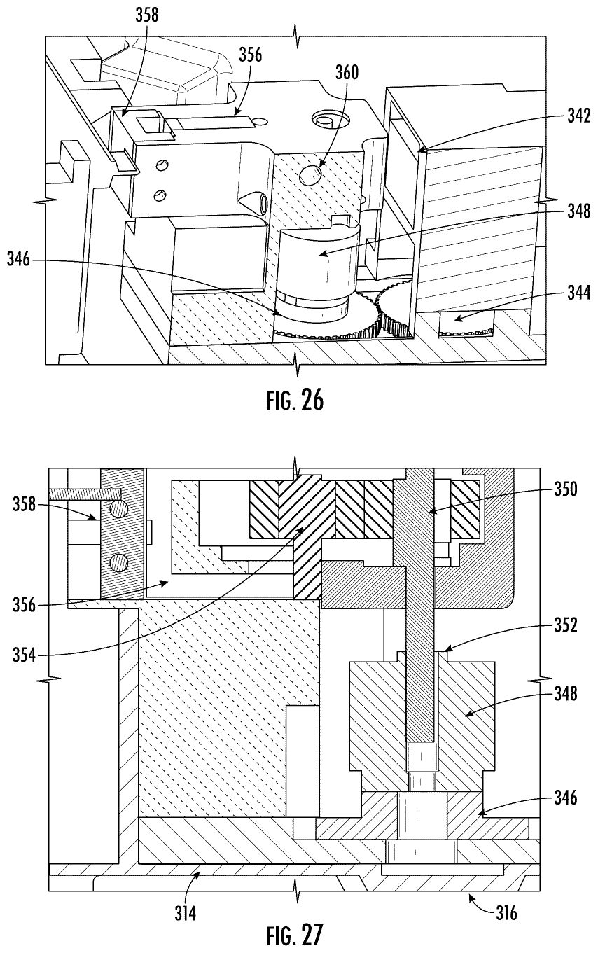

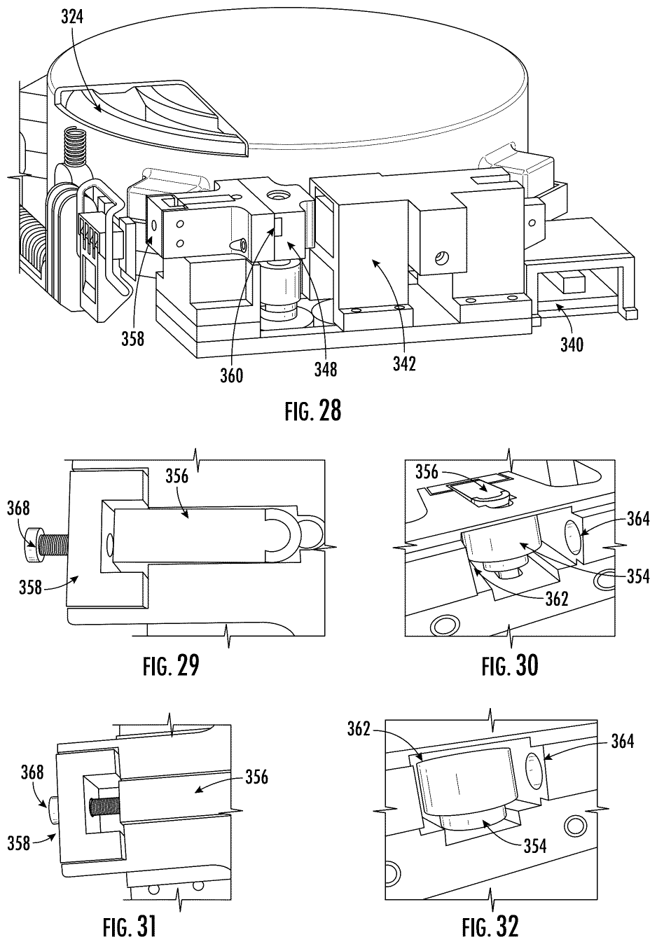

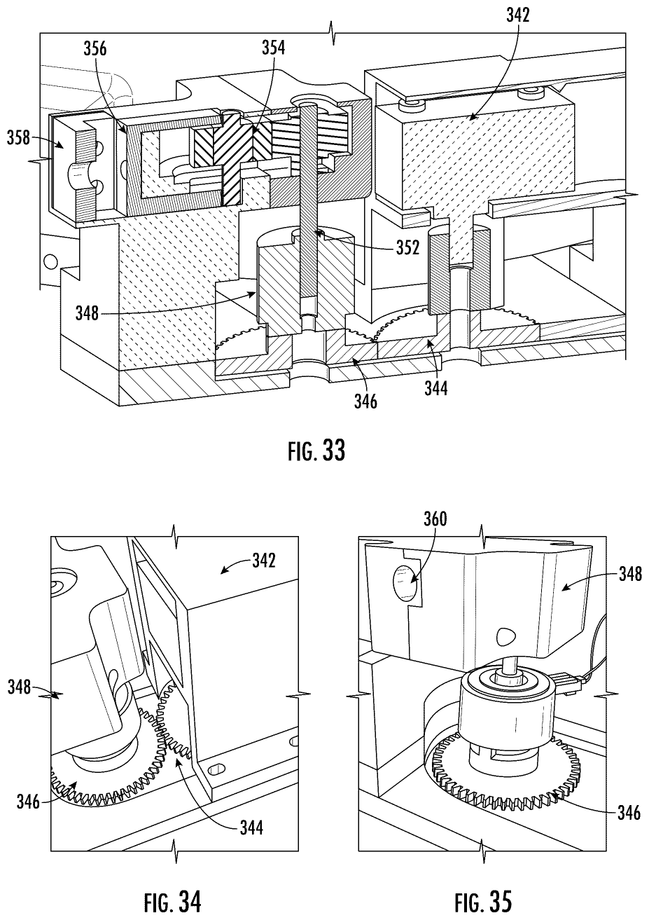

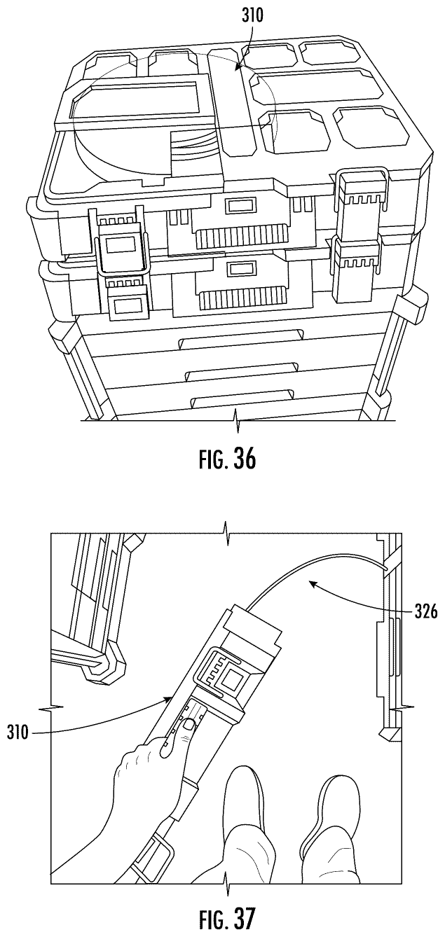

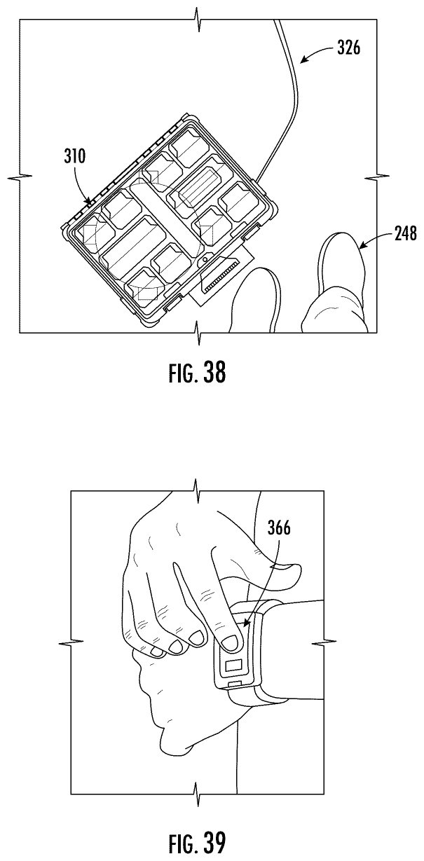

Referring to FIGS. 24-39 various aspects of fish tape unit 310 are provided. Fish tape unit 310 is substantially the same as fish tape unit 110 or fish tape unit 210 except for the differences discussed herein.

In various embodiments, electric motor 342 toggles between a manual mode and an electric assisted mode. When in the manual mode, the fish tape 326 can be manually fished and pulled in a conduit, and when in the electric mode the respooling of the fish tape 326 is electrically assisted by the electric motor 342.

Fish tape unit 310 includes a housing 312 defining a primary storage compartment 334 and a lower surface 314, handle 330 extending from housing 312, a lid 320 coupled to the housing 312, such as pivotally coupled, the lid 320 defining an upper surface 321 opposite the lower surface 314. In various embodiments, fish tape unit 310 includes a plurality of male couplers 316 extending from the lower surface 314, each of the plurality of male couplers 316 configured to engage with a female coupler of a utility module, fish tape 326, a spool 324 rotatably coupled to the housing 312 within the primary storage compartment 334, the spool 324 configured to receive the fish tape 326 that is wound around the spool 324, a first aperture 328 defined by one of the housing 312 and the lid 320, an electric motor 342, and a roller 350 that interfaces with the fish tape 326 as the fish tape 326 is retracted into the housing 312. In various embodiments, fish tape unit 326 includes spool 324 rotatably coupled to the housing 312 within the primary storage compartment 334. In various embodiments, fish tape unit 326 includes fish tape 326 wound around spool 324, fish tape 326 extending through the first aperture 328 as the fish tape 326 is extracted from and retracted into the spool 324. First aperture 328 is defined by one of the housing 312 and the lid 320. Fish tape unit 310 includes latch 318, configured to interface with a latch recess of the utility module the male couplers 316 are coupled to, thereby restricting the male couplers 116 from disengaging from the female couplers.

Fish tape unit 310 includes a plurality of female couplers 322 disposed at upper surface 321, each of the plurality of female couplers 322 configured to detachably and rigidly engage with a male coupler of a utility module (e.g., utility module 192). Lid 320 includes latch recess 332 configured to engage with a latch and prevent sliding disengagement of the female couplers 322 from the male coupler(s). Stated another way, fish tape unit 310 includes a plurality of female couplers 322 disposed at the upper surface 321, each of the plurality of female coupler 322 configured to detachably and rigidly engage with a male coupler of a utility module.

In various embodiments, fish tape unit 310 includes a plurality of couplers (e.g., male couplers 116 and/or female couplers 222 and/or female couplers 322) located on one of the lower surface 314 and the upper surface 321, each of the plurality of couplers configured to detachably and rigidly engage with a corresponding coupler of a utility module.

Electric motor 342 is configured to exert a retrieving force that retracts the fish tape 326 into the housing 312 and around the spool 324. Electric motor 342 is configured to toggle between an off configuration and an on configuration. When the electric motor 342 is in the on configuration, the electric motor 342 retracts the fish tape 326 into the housing 312 and winds the fish tape 326 around the spool 324. Roller 350 interfaces with the fish tape 326 as the fish tape 326 is retracted into the housing 312 and around the spool 324 via the electric motor 342. When the electric motor 342 is in the on configuration the electric motor 342 rotates the roller 350 with respect to the housing 312.

In various embodiments, fish tape unit 310 includes idler 354 configured to exert a varying amount of tensioning force on the fish tape 326 as the electric motor 342 retracts fish tape 326 into the housing 312 and around the spool 324.

Fish tape unit 310 includes PCB (printed control board) 340, which controls electric motor 342. Electric motor 342 is coupled to and rotates motor gear 344. Motor gear 344 is engaged with clutch gear 346. Clutch 348 engages and disengages clutch gear 346 with motor gear 344 to actuate whether roller 350 rotates as a result of force exerted by electric motor 342. Shaft 352 rotational force from clutch gear 346 to roller 350. In use, fish tape 326 enters aperture 360 when being retrieved.

Referring to FIGS. 29-32, fish tape unit 310 further includes a mechanism to provide a varying amount of tensioning force on fish tape 326. In particular, fish tape unit 310 includes back plate 358, tension fork 356, idler 354, and fastener 368. In use, fastener 368 is adjusted to actuate idler 354 out of engagement with fish tape 326 (see FIGS. 29-30) as fish tape 326 exits aperture 362 and enters aperture 364 on the way to spool 324 when fish tape 326 is being retrieved. In various embodiments, fish tape unit 310 includes fastener 368 that is adjusted to actuate the idler 354 into and out of engagement with the fish tape 326 (see FIGS. 31-32) as fish tape 326 exits aperture 362 and enters aperture 364 on the way to spool 324 when fish tape 326 is being retrieved. In this way, idler 354 provides tension on fish tape 326 thereby assisting the retraction of fish tape 326, such as by reducing the chances of fish tape 326 getting tangled. In various embodiments, fish tape unit 310 includes a roller 350 that interfaces with the fish tape 326 as the fish tape 326 is retracted into the housing 312 and around the spool 324 via the electric motor 342, and when the electric motor 342 is in the on configuration the electric motor 342 rotates the roller 350 with respect to the housing 312.

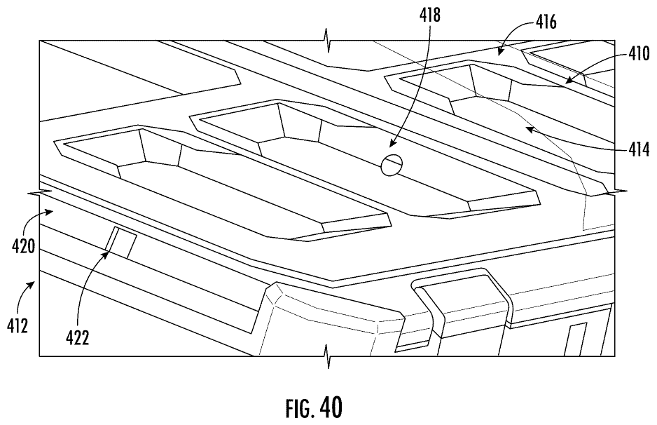

Referring to FIG. 39, in various embodiments remote control, shown as smart watch 366, actuates electric motor 342 on and off. In this way, a user can remotely actuate whether fish tape unit 310 is electrically retrieving fish tape 326. In various embodiments, fish tape unit 310 is configured to be remotely controlled by the remote control, shown as smart watch 366, which actuates electric motor 342 on and off.

In various embodiments, spool 324 and thus also fish tape 326 are removable and replaceable with a different carrier including a different fish tape, thereby facilitating the user changing the size of the spool, the amount of line located on the spool, and/or the type of line located on the spool (e.g., change from a less flexible line to a more flexible line).

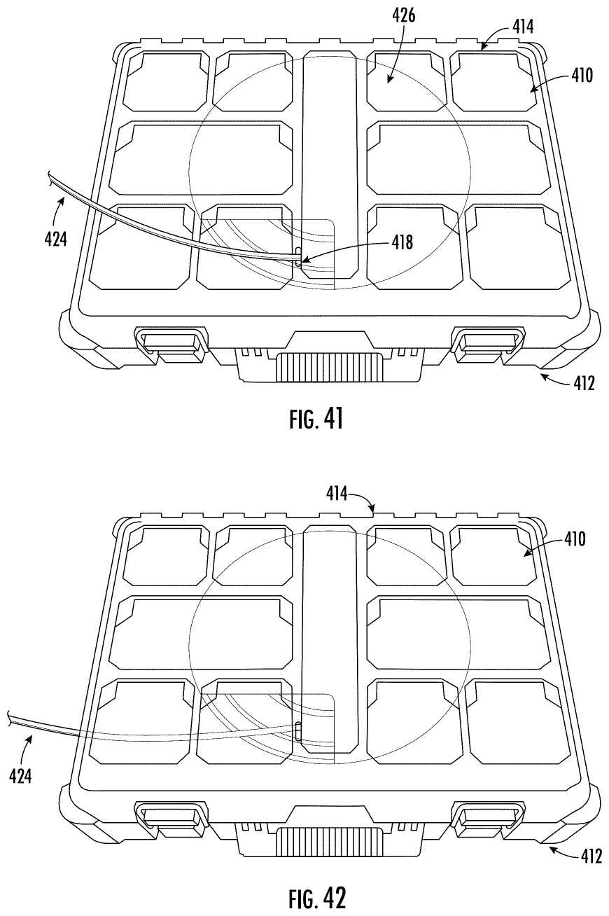

Referring to FIGS. 40-42, various aspects of fish tape unit 410 are provided. Fish tape unit 410 is substantially the same as fish tape unit 110, fish tape unit 210 or fish tape unit 310 except for the differences discussed herein.

Fish tape unit 410 includes housing 412 and lid 414 pivotally coupled to housing 412. Lid 414 includes one or more upper panels 416, at least one of which defines first aperture 418. Lid 414 includes one or more side panels 420, at least one of which defines second aperture 422. Housing 412 includes spool 426, around which fish tape 424 is wound.

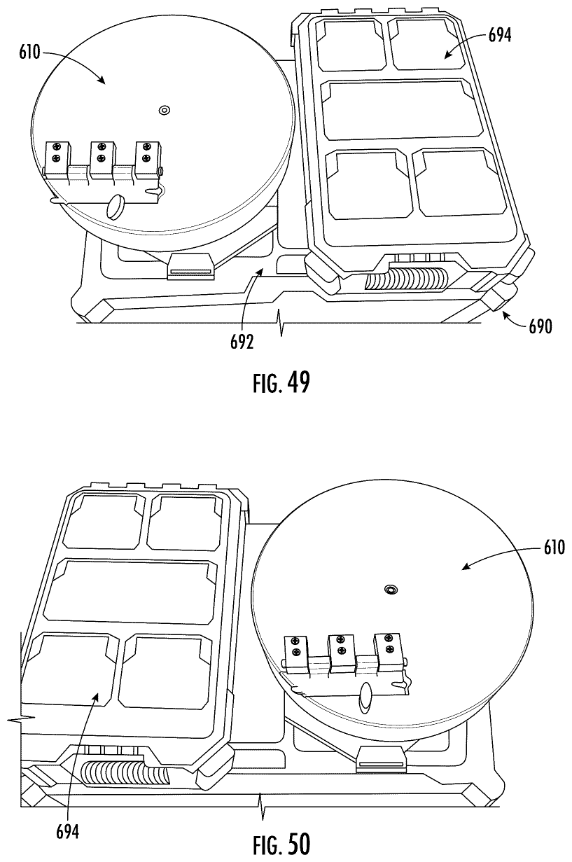

In use, the user can alternate which of first aperture 418 and second aperture 422 that fish tape 424 transits to extend from and be retracted back into housing 412. As a result, fish tape unit 410 can be adjusted to be coupled within a modular system (e.g., see modular system 690 in FIG. 49) at different positions of the modular system. In this way, fish tape unit 410 provides increased flexibility to locations within the modular system that the fish tape unit 410 can function compared to other fish tape units that have only a single aperture through which the fish tape extends. In various embodiments, fish tape unit 410 includes a guide rod and/or an extended lip on lid 414 to reduce the likelihood of fish tape 424 kinking when being fed into fish tape unit 410. In various embodiments, the spool 426 can be quickly swapped from housing 412 and a new spool inserted into housing 412, thereby permitting users to more quickly adjust a length and/or physical feature (e.g., stiffness) of the fish tape being used.

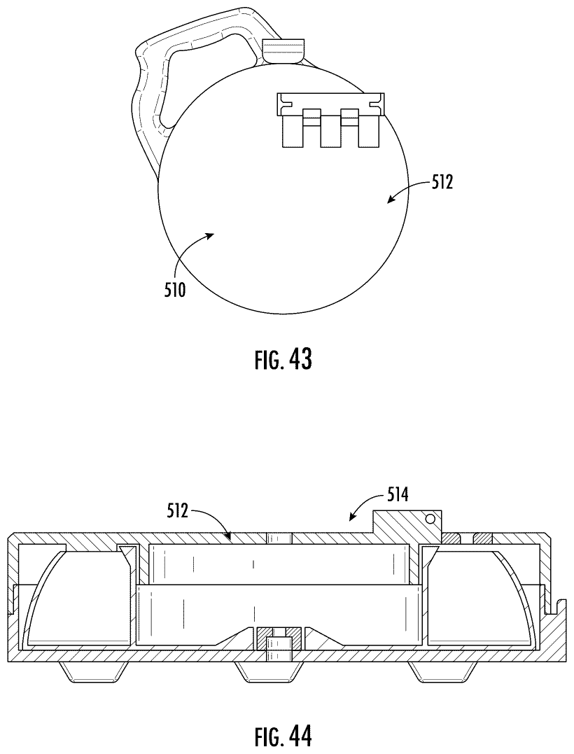

Referring to FIGS. 43-47, various aspects of fish tape unit 510 are provided. Fish tape unit 410 is substantially the same as fish tape unit 110, fish tape unit 210, fish tape unit 310, or fish tape unit 410 except for the differences discussed herein.

Fish tape unit 510 includes housing 512 and lid 514 pivotally coupled to housing 512. Lid 514 includes one or more upper panels 516, at least one of which defines first aperture 518. Lid 514 includes one or more side panels 520, at least one of which defines second aperture 522.

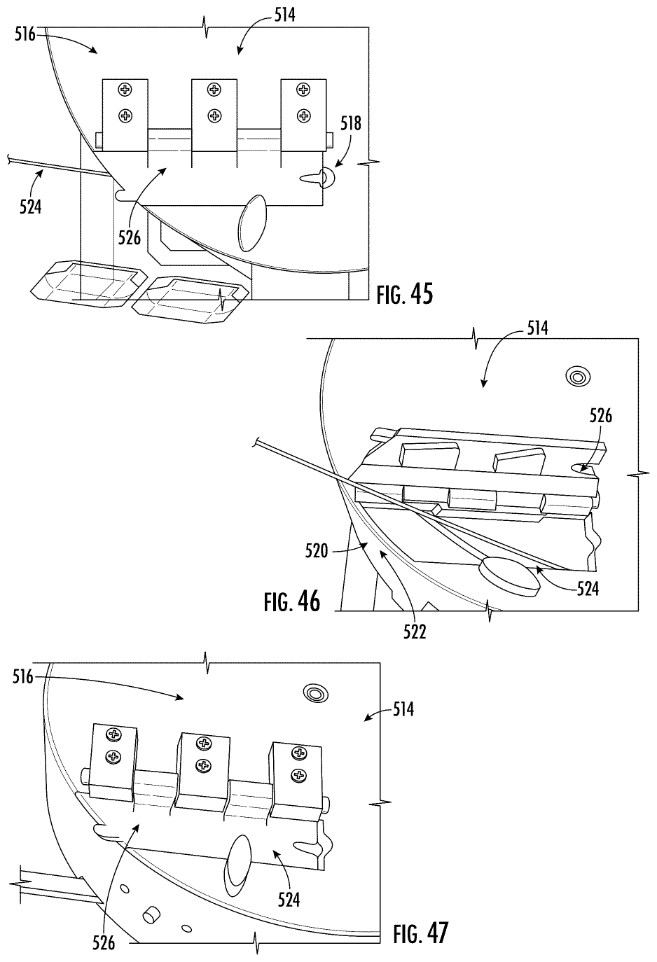

In use, the user can alternate which of first aperture 518 and second aperture 522 that fish tape 524 transits to extend from and be retracted back into housing 512. In particular, cover 526, which is pivotally coupled to lid 514, can be opened (see FIG. 46) to permit the fish tape 524 to exit housing from either first aperture 518 (FIG. 47) or second aperture 522 (FIG. 45). As a result, fish tape unit 510 can be adjusted to be coupled within a modular system (e.g., see modular system 690 in FIG. 49) at different positions of the modular system. In this way, fish tape unit 510 provides increased flexibility to locations within the modular system that the fish tape unit 510 can function compared to other fish tape units that have only a single aperture through which the fish tape extends. In various embodiments, fish tape unit 510 includes a shaft and/or bearings to bias the spool of fish tape unit 510 towards a center of housing 512. In various embodiments, lid 514 extends at least partially into the spool of fish tape unit 510 to facilitate feeding fish tape 524 into fish tape unit 510 and around the spool.

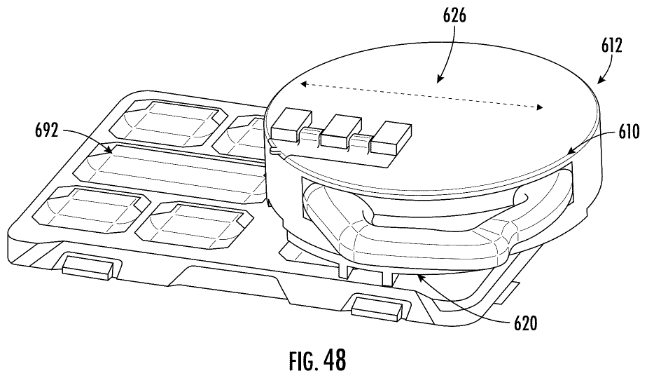

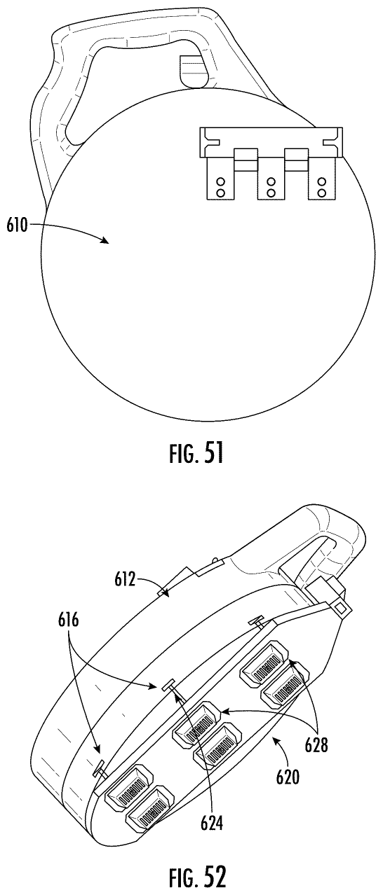

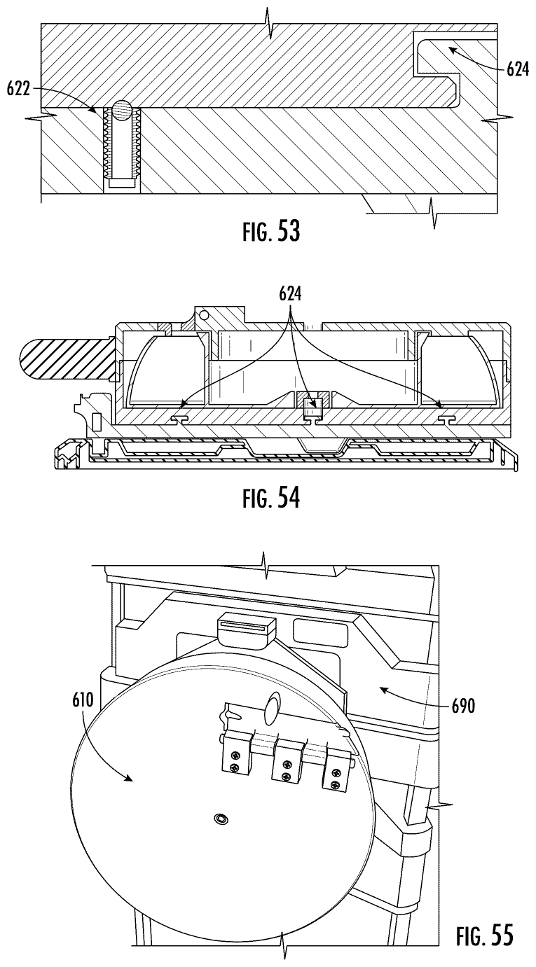

Referring to FIGS. 48-55, various aspects of fish tape unit 610 are provided. Fish tape unit 610 is substantially the same as fish tape unit 110, fish tape unit 210, fish tape unit 310, fish tape unit 410, or fish tape unit 510 except for the differences discussed herein.

Fish tape unit 610 includes housing 612 and base 620. Housing 612 is slidably coupled to base 620 such that housing slides along axis 626 with respect to base 620. In this way, the configuration of fish tape unit 610 can be adjusted between a first configuration of housing 612 and base 620 (FIG. 49) and a second configuration of housing 612 and base 620 (FIG. 50), thereby permitting utility module 694 to be coupled to different locations of upper panel 692.

In various embodiments a modular system, such as a modular storage system, includes a modular unit, such as a modular storage unit, including upper panel 692 (e.g., a lid coupled to a housing of the modular storage unit). The modular system further includes utility module 694 coupled to upper panel 692. In various embodiments, utility module 694 defines a width with respect to a front of upper panel 692 (e.g., the side of upper panel 692 opposite where upper panel 692 is coupled to the housing of the modular unit) that is approximately half the width of the width of upper panel 692 (e.g., within 20% of the width, or more specifically within 10% of the width, or more specifically within 5% of the width). The modular system further includes fish tape unit 610 coupled to upper panel 692. In various embodiments, fish tape unit 610 is coupled to one of more female couplers of upper panel 692 on the half of upper panel 692 opposite the half that utility module 694 is coupled to. In various embodiments, fish tape unit 610 does not extend past a center line of upper panel 692 (e.g., a line bisecting upper panel 692 extending from a rear of upper panel 692 to a front of upper panel 692), thereby permitting both fish tape unit 610 and utility module 694 to be simultaneously coupled to upper panel 692. Thus, both fish tape unit 610 and utility module 694 are simultaneously accessible (e.g., to be opened and/or removed from upper panel 692).

Housing 612 defines channels 616 that receive projections 624 extending from base 620. After housing 612 has been moved with respect to base 620 to the desired position, detent 622 extends from housing 612 to interface against base 620 to bias housing 612 from moving with respect to base 620.

Housing 612 includes a plurality of male couplers 628, such as similar to male couplers 116, that extend from housing 612. Male couplers 628 are configured to rigidly and detachably couple housing 612 to an upper panel 692 of a modular system 690, such as a lid of a utility module 694. In various embodiments, fish tape unit 610 includes a shaft (e.g., a metal shaft) and/or bearings to bias the spool of fish tape unit 510 towards a center of housing 512.

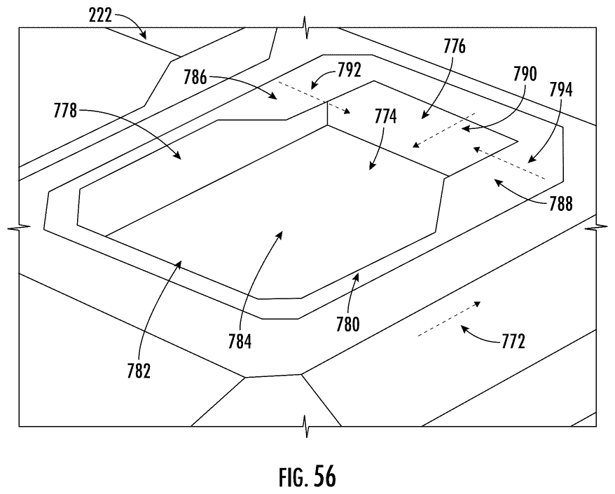

Referring to FIG. 56, various aspects of female coupler 222 are shown. Female couplers 322 are structurally and functionally the same as female couplers 222 except as otherwise described.

Female coupler 222 includes a recessed surface 774, such as below a top surface of a lid. Backwall 776, opposing front wall 782, first sidewall 778, and opposing second sidewall 780 extend upward from recessed surface 774. Female coupler 222 includes a pocket 784 collectively defined by recessed surface 774, backwall 776, front wall 782, first sidewall 778, and second sidewall 780.

First rib 786 extends from backwall 776 and first sidewall 778 above pocket 784 and/or recessed surface 774. In particular, first rib 786 extends in direction 792 from first sidewall 778 and first rib 786 extends in direction 790 from backwall 776. Second rib 788 extends from backwall 776 and second sidewall 780 above pocket 784 and/or recessed surface 774. In particular, second rib 788 extends in direction 794 from second sidewall 780 and second rib 788 extends in direction 790 from backwall 776.

To couple female coupler 222 to a male coupler, the male coupler moves in direction 772 with respect to the female coupler 222.

In various embodiments, each of the plurality of female couplers 222 includes a recessed surface 774, a first rib 786, and a second rib 788, the first rib 786 and the second rib 788 each extending over the recessed surface 774.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A fish tape unit comprising:
a housing defining a primary storage compartment and a lower surface;
a lid coupled to the housing;
a plurality of male couplers extending from the lower surface, each of the plurality of male couplers configured to detachably and rigidly engage with a female coupler of a utility module;
a spool rotatably coupled to the housing within the primary storage compartment;
a fish tape wound around the spool, the fish tape extending through a first aperture, the fish tape configured to be extended out of and retracted into the housing, wherein the first aperture is defined by one of the housing and the lid; and
an electric motor configured to exert a retrieving force that retracts the fish tape into the housing and winds the fish tape around the spool, the electric motor configured to toggle between an off configuration and an on configuration, wherein when the electric motor is in the on configuration the electric motor retracts the fish tape into the housing and winds the fish tape around the spool.

2. The fish tape unit of claim 1, comprising a latch configured to interface with a latch recess of the utility module, thereby restricting the plurality of male couplers from disengaging from the utility module.

3. The fish tape unit of claim 1, comprising a foot button configured to be actuated by a foot of a user when the fish tape unit is on the ground, the foot button actuating the electric motor between the off configuration and the on configuration.

4. The fish tape unit of claim 1, each of the plurality of male couplers comprising a body extending below the lower surface and a first tongue extending from the body and offset from and below the lower surface.

5. The fish tape unit of claim 4, the first tongue defining a first channel between the lower surface and the first tongue, the first channel comprising a front open end and a back closed end.

6. The fish tape unit of claim 5, comprising a latch configured to interface with a latch recess of the utility module, thereby restricting the plurality of male couplers from disengaging from the utility module.

7. The fish tape unit of claim 1, each of the plurality of male couplers comprising a body extending below the lower surface, a first tongue, and a second tongue, the first tongue and the second tongue both extending from the body and both offset from and below the lower surface.

8. The fish tape unit of claim 7, the first tongue defining a first channel between the lower surface and the first tongue, the second tongue defining a second channel between the lower surface and the second tongue, the first channel and second channel each extending on opposing sides of the body, each of the first channel and the second channel comprising a front open end and a back closed end.

9. The fish tape unit of claim 8, comprising a latch configured to interface with a latch recess of the utility module, thereby restricting the plurality of male couplers from disengaging from the utility module.

10. A fish tape unit comprising:
a housing defining a primary storage compartment and a lower surface;
a lid pivotally coupled to the housing, the lid defining an upper surface opposite the lower surface;
a plurality of female couplers disposed at the upper surface, each of the plurality of female coupler configured to detachably and rigidly engage with a male coupler of a utility module;
a spool rotatably coupled to the housing within the primary storage compartment;
a fish tape wound around the spool, the fish tape extending through a first aperture, the fish tape configured to be extended out of and retracted into the housing, wherein the first aperture is defined by one of the housing and the lid; and
an electric motor configured to exert a retrieving force that retracts the fish tape into the housing and winds the fish tape around the spool, the electric motor configured to toggle between an off configuration and an on configuration, wherein when the electric motor is in the on configuration the electric motor retracts the fish tape into the housing and winds the fish tape around the spool.

11. The fish tape unit of claim 10, the lid comprising a latch recess configured to engage with a latch and prevent sliding disengagement of the plurality of female couplers from the male coupler.

12. The fish tape unit of claim 10, wherein the electric motor toggles between a manual mode and an electric assisted mode, wherein when in the manual mode the fish tape can be manually fished and pulled in a conduit, and when in the electric assisted mode respooling of the fish tape is electrically assisted by the electric motor.

13. The fish tape unit of claim 10, comprising an idler configured to exert a varying amount of tensioning force on the fish tape as the electric motor retracts the fish tape into the housing and around the spool.

14. The fish tape unit of claim 13, comprising a fastener that is adjusted to actuate the idler into and out of engagement with the fish tape.

15. The fish tape unit of claim 10, wherein the fish tape unit is configured to be remotely controlled by a remote control, which actuates the electric motor on and off.

16. The fish tape unit of claim 10, each of the plurality of female couplers comprising a recessed surface, a first rib, and a second rib, the first rib and the second rib each extending over the recessed surface.

17. A fish tape unit comprising:
a housing defining a primary storage compartment and a lower surface;
a lid coupled to the housing, the lid defining an upper surface opposite the lower surface;
a plurality of couplers located on one of the lower surface and the upper surface, each of the plurality of couplers configured to detachably and rigidly engage with a corresponding coupler of a utility module;
a spool rotatably coupled to the housing within the primary storage compartment;
a fish tape wound around the spool, the fish tape extending through a first aperture, the fish tape configured to be extended out of and retracted into the housing, wherein the first aperture is defined by one of the housing and the lid;
an electric motor configured to exert a retrieving force that biases the fish tape towards being retracted into the housing and around the spool, the electric motor configured to toggle between an off configuration and an on configuration, wherein when the electric motor is in the on configuration the electric motor exerts a retrieving force that biases the fish tape towards being retracted into the housing and around the spool; and
a roller that interfaces with the fish tape as the fish tape is retracted into the housing and around the spool via the electric motor, wherein when the electric motor is in the on configuration the electric motor rotates the roller with respect to the housing.

18. The fish tape unit of claim 17, wherein the electric motor toggles between a manual mode and an electric assisted mode, wherein when in the manual mode the fish tape can be manually fished and pulled in a conduit, and when in the electric assisted mode respooling of the fish tape is electrically assisted via the electric motor.

19. The fish tape unit of claim 17, comprising:
an idler configured to exert a varying amount of tensioning force on the fish tape as the electric motor retracts the fish tape into the housing and around the spool; and
a fastener that is adjusted to actuate the idler into and out of engagement with the fish tape.

20. The fish tape unit of claim 17, wherein the fish tape unit is configured to be remotely controlled by a remote control, which actuates the electric motor on and off.
